(19) United States
(12) Patent Application Publication
(10) Pub. No.: US 2026/0048962 A1
(43) Pub. Date: Feb. 19, 2026

(54) ELEVATOR SYSTEM HAVING THREE COMBINED GUIDING POINTS FOR ELEVATOR CAR AND COUNTERWEIGHT

(71) Applicant: Otis Elevator Company, Farmington, CT (US)

(72) Inventor: Jose Miguel Aguado, Leganés (ES)

(21) Appl. No.: 19/299,963

(22) Filed: Aug. 14, 2025

(30) Foreign Application Priority Data
Aug. 14, 2024 (EP) 24382909.0

(51) Int. Cl. B66B 7/02; B66B 7/06; B66B 11/00

(52) U.S. Cl. CPC B66B 7/021; B66B 11/0045; B66B 7/06

(57) ABSTRACT

An elevator system (1) for transporting goods and/or passengers. The elevator system (1) includes an elevator car (2), a counterweight (3) being motion coupled with the elevator car (2), and several guide rails (4a, 4b, 4c). The guide rails (4a, 4b, 4c) run parallel to each other and guide the elevator car (2) and the counterweight (3) during their up and down movement. In total three guide rails (4a, 4b, 4c) are provided which are distanced from each other and at least one of these guide rails (4a, 4b, 4c) has a first guiding portion (6) receiving the elevator car (2) and a second guiding portion (7) receiving the counterweight (3).

### FOREIGN PRIORITY

This application claims priority to European Patent Application No. 24382909.0, filed Aug. 14, 2024, and all the benefits accruing therefrom under 35 U.S. C. § 119, the contents of which in its entirety are herein incorporated by reference.

### TECHNICAL FIELD OF INVENTION

The disclosure relates to an elevator system for transporting goods and/or passengers. The elevator system comprises an elevator car, a counterweight being motion coupled with the elevator car, and several guide rails.

### BACKGROUND OF THE INVENTION

It is generally known to use guide rails to guide the corresponding movements of the elevator car and its counterweight. It is also well known that the arrangement of these guide rails is dependent on the arrangement of the elevator car and the counterweight and the associated drive components relative to each other and inside the hoistway. However, there is a conflict between sufficiently robust guidance of the moving components and the reduction of costly guide rails.

In this respect, it is an object of the present disclosure to provide an improved elevator system where the known disadvantages of the prior art are avoided.

This is solved by an elevator system according to the independent claim. Alternative embodiments are the subject matter of the dependent claims.

### SUMMARY OF THE INVENTION

According to an aspect an elevator system for transporting goods and/or passengers is provided. The elevator system comprises an elevator car, a counterweight being motion coupled with the elevator car, and several guide rails. The guide rails run parallel to each other (and may be fixed to a wall of a hoistway) and guide the elevator car and the counterweight during their up and down movement. In total (that means exactly/not more or less than) three guide rails are provided which are distanced from each other. Each guide rail may run continuously from the bottom to the top of the hoistway. At least one of these guide rails may be configured as a double guide rail, that means having a first guiding portion receiving/holding/guiding the elevator car and a second guiding portion receiving/holding/guiding the counterweight. This makes it possible to reduce the number of guide rails required while still achieving sufficiently stable guidance of the elevator car and the counterweight. At the same time, this allows the hoistway to be used in a space-intensive manner, as the elevator car in particular can be designed to be as large as possible.

According to an aspect the three guide rails are arranged on different sides of an imaginary rectangle. The three guide rails can be arranged on three different walls of a rectangular hoistway. This allows a robust support with as few guide rails as possible.

According to an aspect a first guide rail and a second guide rail each are configured as a double guide rail. This makes different guide rails particularly space-saving.

According to an aspect the first guide rail and the second guide rail are each arranged on opposing sides of the imaginary rectangle. This also allows a robust support and at the same time a space-saving arrangement of the guide rails.

According to an aspect several rail sections of the guiding portions of the at least one double guide rail can be arranged parallel to each other. This makes the guide rail even more space-saving.

According to an aspect rail sections of the guiding portions of the at least one double guide rail can also be arranged at an angle (/perpendicular) to each other. This ensures a more simple design of the guiding devices of the elevator car and the counterweight.

According to an aspect the at least one double guide rail is configured as a single part (i.e. a part formed from one material as a whole). This enables a simple production process of the guide rail.

According to an aspect a third guide rail is configured as a single guide rail (having exactly one guiding portion). This ensures a structure of the elevator system that is as simple as possible.

According to an aspect the third guide rail can be arranged on a side of the rectangle, which side is perpendicular to another side including the first guide rail (/to which the first guide rail is fixed) and/or perpendicular to another side including the second guide rail (/to which the second guide rail is fixed). This again ensures a simple structure, but at the same time a structure that is as rigid as possible for achieving a stable guide.

According to an aspect the third guide rail is arranged distanced to a center of a first car side of the elevator car. This allows the third guide rail to be cleverly attached to a suitable area of the hoistway.

According to an aspect the three guide rails are arranged on two sides of the elevator car facing away from each other. This ensures that the elevator car in particular is guided with sufficient stability.

According to an aspect a 2:1-suspension connects the elevator car and the counterweight with each other. This allows the elevator system to benefit to a particular extent from the space-saving arrangement of the guide rails.

According to an aspect a drive machine and/or a drive pulley for moving the elevator car are/is arranged above or below the elevator car and the counterweight. According to this aspect or another aspect the drive machine and/or the drive pulley at least partially cover the elevator car and/or the counterweight when seen from the top or the bottom of the hoistway. This enables the additional components to be accommodated in as little space as possible.

According to an aspect the elevator car is connected to a tension member, which tension member has an underslung configuration.

In other words, the proposed concept is to combine (three) guide rails for the elevator car and its counterweight looking for better hoistway efficiency.

Two (first and second) guide rails can be used to guide the counterweight and the car. These guide rails can have the structural function to withstand car and counterweight safety gear engagement. Moreover, different constructive solutions can be used as steel profiles or even sheet metal geometry.

A third guide rail will just be used to limit side to side car movement. This concept will provide the following benefits: a) Improve hoistway efficiency by reducing distance from car walls to hoistway wall; b) Significant savings from guide rails material cost and reduction of number of guide rail brackets; and c) Savings in installation time at jobsite.

### BRIEF DESCRIPTION OF THE DRAWINGS

Embodiments of the present disclosure, as an example only, will be described in the following with reference to the drawings. In the drawings:

FIG. 1 shows a top view of an elevator system inside a hoistway according to a first embodiment;

FIG. 2 shows a schematic side view of the elevator system of FIG. 1; and

FIG. 3 shows a top view of a further elevator system inside a hoistway according to a second embodiment.

### DETAILED DESCRIPTION OF THE INVENTION

In the following, embodiments of the present disclosure are explained with reference to the drawings. The same elements are assigned with the same reference numbers in the drawings. It is to be noted that the embodiments are described for exemplary purposes only and the description of the embodiments is not intended to limit the scope of the present disclosure.

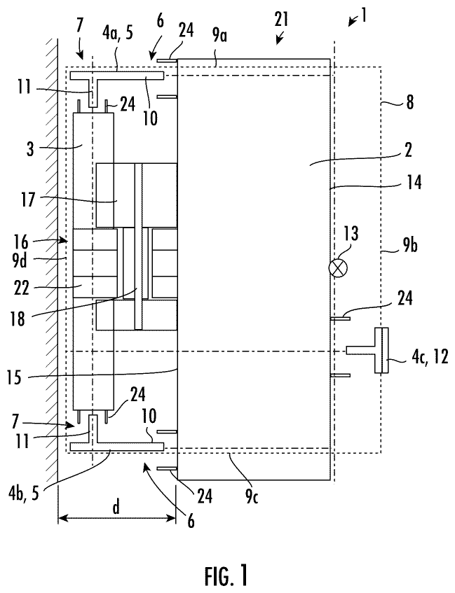

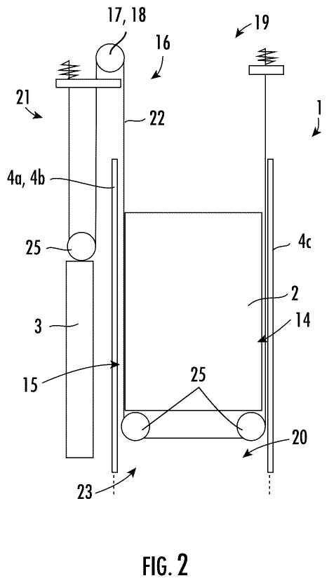

FIGS. 1 and 2 in combination show the structure of an elevator system 1/elevator arrangement according to a first embodiment. The elevator system 1 can generally be used in a hoistway 21 of a building. Alternatively or additionally, this elevator system 1 can be designed as cantilever-type.

FIG. 2 also shows that an elevator car 2 and its associated counterweight 3 are suspended in the hoistway 21 by means of a 2:1 suspension 16. A drive machine 17, which in turn drives a drive pulley 18, is arranged in an upper area of the hoistway 21. The drive pulley 18 is connected to the elevator car 2 and the counterweight 3 in the usual way via a tension member 22, like a roping or a belt, which is driven/deflected by a number of deflection sheaves 25. By rotating the drive pulley 18 in a respective (first or second) direction of rotation, the elevator car 2 and the counterweight 3 are thus moved up and down in the hoistway 21 in the usual manner.

It can also be seen that the tension member 22 is accommodated by the elevator car 2 via an underslung configuration 23. The tension member 22 is therefore passed under the elevator car 2 and guided on its underside by deflection sheaves 25.

As can also be seen in the plan view of FIG. 1, there are several guide rails 4a, 4b, 4c, which serve to guide the elevator car 2 and the counterweight 3 during their up and down movements. These guide rails 4a, 4b, 4c run parallel to each other along the length of the hoistway 21. Each guide rail 4a, 4b, 4c may run continuously from a bottom 20 to a top 19 of the hoistway 21.

It should be noted in this respect that guiding devices 24 are attached to the elevator car 2 and the counterweight 3 respectively, which are each guided along a guide rail 4a, 4b, 4c. In the usual way, corresponding guiding rollers and safety devices can be interposed here between each guiding device 24 and each guide rail 4a, 4b, 4c in order to ensure safe guidance and movement of the elevator car 2 and the counterweight 3. The guiding devices 24 can be designed in different ways, like guide shoes rollers or other devices that serve to guide the elevator car 2 and the counterweight 3 respectively along the guide rails 4a, 4b, 4c.

In the embodiment example of FIG. 1, a total of three guide rails 4a, 4b, 4c are provided, which are positioned on three different sides 9a, 9b, 9c of an imaginary rectangle 8. Those sides 9a, 9b, 9c of the rectangle 8 may represent walls of the hoistway 21 to which the guide rails 4a, 4b, 4c are indirectly (e. g, via brackets) or directly (e.g., with bolts or screw) attached. The walls of the hoistway 21 to which the guide rails 4a, 4b, 4c are attached do not, of course, form part of the elevator system 1 itself.

Two guide rails, namely a first guide rail 4a and a second guide rail 4b are each used to guide both, the elevator car 2 and the counterweight 3. The first guide rail 4a and the second guide rail 4b are arranged on opposite sides 9a, 9c of the rectangle 8. The (third) side 9c of the rectangle 8 can be a side to which a door of the elevator car 2 and thus also landing doors are arranged. The (first) side 9a of the rectangle 8 can be a side to which a (permanantly closed) rear side of the elevator car 2 is arranged. Alternatively, also the first side 9a of the rectangle 8 can be a side to which a door of the elevator car 2 and thus also landing doors are arranged.

The first guide rail 4a and the second guide rail 4b are designed as double guide rails 5, as they each have two guide sections 6, 7, one of which is used to guide the elevator car 2 and the other to guide the counterweight 3.

According to FIG. 1, the first and second guide rails 4a, 4b each have two rail sections 10, 11 which project into/towards corresponding guiding devices 24 of the elevator car 2 or the counterweight 3. These rail sections 10, 11 can be aligned parallel to each other or perpendicular to each other (viewed in cross-section), as shown in FIG. 1. Each rail section 10, 11 is in turn again part of a guide section 6, 7.

In addition to the first guide rail 4a and the second guide rail 4b, there is a third guide rail 4c. This third guide rail 4c is designed as a single guide rail 12 and therefore has only one rail section that interacts with only one guiding device 24, namely a guiding device 24 of the elevator car 2.

The third guide rail 4c is arranged on a further (second) side 9b of the rectangle 8, namely that side 9b which is aligned perpendicular to the side 9a of the rectangle 8 to which the first guide rail 4a is attached and perpendicular to the side 9c of the rectangle 8 to which the second guide rail 4b is attached. The sides of the elevator car 2 could be arranged towards the two sides 9b and 9d. As an alternative or in addition to the previously explained arrangement of the elevator car doors/landings, the second side 9b of the rectangle 8 can be a side to which a door of the elevator car 2 and thus also landing doors are arranged.

All three guide rails 4a, 4b, 4c thus jointly span the square/rectangle 8.

It can also be seen that the third guide rail 4c is arranged towards a first car side 14, like a front side, of the elevator car 2, while the other two guide rails 4a, 4b are arranged towards a second car side 15, like a rear side, of the elevator car 2.

The third guide rail 4c is arranged laterally offset to a center 13 (/to an axis running in the longitudinal direction of the hoistway 21 and arranged centrally as seen from the first car side 14). In FIG. 1, the third guide rail 4c is positioned closer to the second guide rail 4b than to the first guide rail 4a. This arrangement allows the third guide rail 4c to be positioned hidden to the side of a door of the elevator car 2 or a landing door.

One side 9d of the rectangle 8 can be free of a guide rail. A distance between this (fourth) side 9d and the elevator car 2 is marked with the letter “d” in FIG. 1 in this embodiment and is smaller than the depth (distance between first car side 14 and second car side 15) of the elevator car 2.

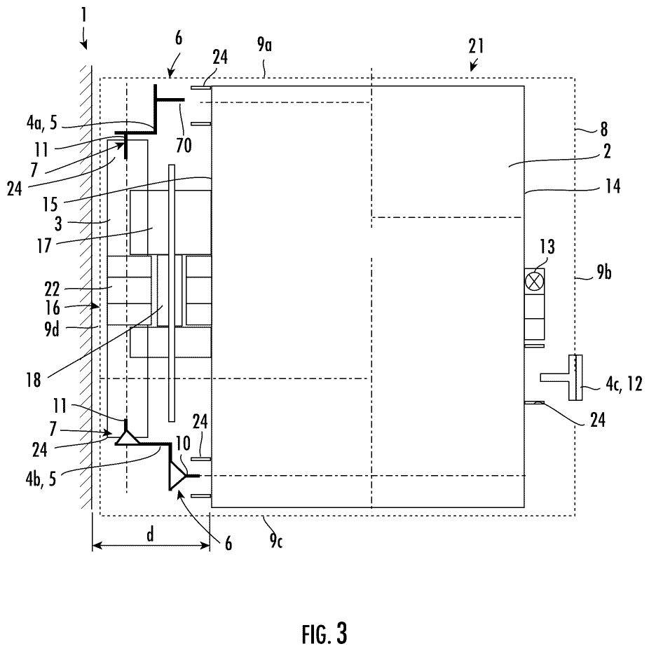

According to the second embodiment shown in FIG. 3, it can be seen that the depth of the elevator car 2 can also be many times greater than this distance d.

FIG. 3 shows the first and second guide rails 4a and 4b in somewhat greater detail, from which it can also be seen that these are preferably implemented as one-piece/integral guide rails. Each guide rails 4a, 4b, 4c can be made of steel profiles or of sheet metal construction. A base portion of the first and second guide rails 4a, 4b connecting the two guiding portions 6, 7 with each other may be bent by 90° between the two guiding portions 6, 7.

All further details of the second embodiment example largely correspond to those of the first embodiment example, so that for the sake of brevity reference is made to the first embodiment example with regard to the further construction and function.

What is claimed is:

1. An elevator system (1) for transporting goods and/or passengers, the elevator system (1) comprising:
an elevator car (2),
a counterweight (3) being motion coupled with the elevator car (2), and
several guide rails (4a, 4b, 4c) that run parallel to each other and that guide the elevator car (2) and the counterweight (3) during their up and down movement,
characterized in that
in total three guide rails (4a, 4b, 4c) are provided which are distanced from each other and at least one of these guide rails (4a, 4b, 4c) has a first guiding portion (6) receiving the elevator car (2) and a second guiding portion (7) receiving the counterweight (3).

2. The elevator system (1) according to claim 1, characterized in that the three guide rails (4a, 4b, 4c) are arranged on different sides (9a, 9b, 9c) of an imaginary rectangle (8).

3. The elevator system (1) according to claim 1, characterized in that a first guide rail (4a) and a second guide rail (4b) each having a first guiding portion (6) and a second guiding portion (7).

4. The elevator system (1) according to claim 3, characterized in that the first guide rail (4a) and the second guide rail (4b) are each arranged on opposing sides (9a, 9c) of the imaginary rectangle (8).

5. The elevator system (1) according to claim 1, characterized in that rail sections (10, 11) of the guiding portions (4, 5) of the same guide rail (4a, 4b), when viewed in cross-section, protrude parallel to each other.

6. The elevator system (1) according to claim 1, characterized in that rail sections (10, 11) of the guiding portions (4, 5) of the same guide rail (4a, 4b), when viewed in cross-section, protrude at an angle to each other, in particular at an angle of 90°.

7. The elevator system (1) according to claim 1, characterized in that the at least one double guide rail (5) is configured as an integral part.

8. The elevator system (1) according to claim 1, characterized in that a third guide rail (4c) is configured as a single guide rail (12).

9. The elevator system (1) according to claim 8, characterized in that the third guide rail (4c) is arranged on a side (9b) of the rectangle (8), which side (9b) is perpendicular to another side (9a) including the first guide rail (4a) and/or perpendicular to another side (9c) including the second guide rail (4b).

10. The elevator system (1) according to claim 8, characterized in that the third guide rail (4c) is arranged distanced to a center (13) of a first car side (14) of the elevator car (2).

11. The elevator system (1) according to claim 1, characterized in that the three guide rails (4a, 4b, 4c) are arranged on two sides (14, 15) of the elevator car (2) facing away from each other.

12. The elevator system (1) according to claim 1, characterized in that a 2:1-suspension (16) connects the elevator car (2) and the counterweight (3) with each other.

13. The elevator system (1) according to claim 1, characterized in that a drive machine (17) and/or a drive pulley (18) for moving the elevator car (2) are/is arranged above or below the elevator car (2) and the counterweight (3).

14. The elevator system (1) according to claim 13, characterized in that the drive machine (17) and/or the drive pulley (18) at least partially cover the elevator car (2) and/or the counterweight (3) when seen from the top (19) or the bottom (20) of a hoistway (21).

15. The elevator system (1) according to claim 1, characterized in that the elevator car (2) is connected to a tension member (22) having an underslung configuration (23).
